(19) United States
(12) Patent Application Publication
(10) Pub. No.: US 2016/0353713 A1
(43) Pub. Date: Dec. 8, 2016

(54) AVIAN BEAK TRIMMING CHAIN

(71) Applicant: Rose Acre Farms, Inc., Seymour, IN (US)

(72) Inventor: Marcus D. Rust, Remington, IN (US)

(21) Appl. No.: 14/731,266

(22) Filed: Jun. 4, 2015

(51) Int. Cl. A01K 39/014; A01K 39/02; A01K 39/01

(52) U.S. Cl. CPC A01K 39/014; A01K 39/0106; A01K 39/0113; A01K 39/02

(57) ABSTRACT

A beak trimming device is provided. A chain feeding system is also provided. The system includes a trough operative to receive an avian attractant. A feeder chain is disposed in the trough. The feeder chain includes at least one link and/or coupling that includes one or more abrasive surfaces configured to contact and trim a beak of a bird accessing the attractant. In some embodiments, the attractant is feed.

### TECHNICAL FIELD OF THE DISCLOSED EMBODIMENTS

The embodiments herein generally relate to animal husbandry devices and, more particularly, to avian beak trimming devices.

### BACKGROUND OF THE DISCLOSED EMBODIMENTS

Beak trimming involves removal of part of the beak of avians such as poultry, especially layer hens and turkeys, although it may also be performed on quail, ducks, and other species. In aviaries, birds often need to have their beaks trimmed in order to prevent injury to themselves or other birds. Beak trimming is typically done manually using a heated blade or infrared treatment. However, such manual methods are very labor intensive and expensive.

A need remains for a device that is inexpensive and requires minimal labor to trim the beaks of birds.

### SUMMARY OF THE DISCLOSED EMBODIMENTS

In an embodiment, a beak trimming device is disclosed comprising: a feeder chain comprising a plurality of links, wherein at least one of the links comprises an interior cavity constructed and arranged to hold a quantity of avian attractant; and further wherein at least one of the links comprises a first abrasive surface disposed on at least a portion of the at least one link, the first abrasive surface constructed and arranged to remove material incrementally from an avian beak that is moved across the first abrasive surface when accessing the avian attractant.

In a further embodiment of the above, the abrasive surface comprises an abrasive grit applied to at least a portion of the at least one link.

In a further embodiment of any of the above, the abrasive surface comprises a roughening of a surface of at least a portion of the at least one link.

In a further embodiment of any of the above, the abrasive surface comprises at least one ridge disposed on at least a portion of the at least one link.

In a further embodiment of any of the above, the at least one ridge comprises a plurality of ridges disposed on at least a portion of the at least one link.

In a further embodiment of any of the above, a plurality of slots are formed through at least a portion of the at least one link, wherein the plurality of ridges comprise material of the at least one link adjacent a respective one of the plurality of slots bent away from a plane of the at least one link.

In a further embodiment of any of the above, a quantity of avian attractant is disposed in the interior cavity.

In a further embodiment of any of the above, the attractant is selected from the group consisting of: avian feed, water, treat, and grit.

In a further embodiment of any of the above, a coupling joins a first one of the plurality of links to a second one of the plurality of links; wherein the coupling comprises a second abrasive surface disposed on at least a portion of the coupling, the second abrasive surface constructed and arranged to remove material incrementally from an avian beak that is moved across the second abrasive surface when accessing the avian attractant.

In another embodiment, an avian chain feeding system is disclosed comprising: a trough constructed and arranged to receive an avian attractant; a feeder chain comprising a plurality of links, wherein at least one of the links comprises an interior cavity constructed and arranged to hold a quantity of the avian attractant; and further wherein at least one of the links comprises a first abrasive surface disposed on at least a portion of the at least one link, the first abrasive surface constructed and arranged to remove material incrementally from an avian beak that is moved across the first abrasive surface when accessing the avian attractant; and a drive unit operatively coupled to the feeder chain, wherein the drive unit is constructed and arranged to move the feeder chain through the trough.

In a further embodiment of any of the above, a storage container is constructed and arranged to hold the avian attractant and supply the avian attractant to the trough under force of gravity.

In a further embodiment of any of the above, a corner unit is provided; wherein the trough comprises at least a first trough section and a second trough section, each trough section including a proximal end and a distal end; and wherein the corner unit couples the proximal end of the first trough section to the distal end of the second trough section.

In a further embodiment of any of the above, the first trough section is oriented substantially 90 degrees from the second trough section when the first trough section and the second trough section are coupled to the corner unit.

In a further embodiment of any of the above, the trough comprises a feed trough.

In a further embodiment of any of the above, a grill is disposed over the trough, wherein the grill is constructed and arranged to prevent a bird from entering the trough while still allowing access to the trough for accessing the avian attractant therefrom.

In a further embodiment of any of the above, the abrasive surface comprises an abrasive grit applied to at least a portion of the at least one link.

In a further embodiment of any of the above, the abrasive surface comprises a roughening of a surface of at least a portion of the at least one link.

In a further embodiment of any of the above, the abrasive surface comprises at least one ridge disposed on at least a portion of the at least one link.

In a further embodiment of any of the above, the at least one ridge comprises a plurality of ridges disposed on at least a portion of the at least one link.

In a further embodiment of any of the above, a plurality of slots are formed through at least a portion of the at least one link, wherein the plurality of ridges comprise material of the at least one link adjacent a respective one of the plurality of slots bent away from a plane of the at least one link.

In a further embodiment of any of the above, a quantity of avian attractant is disposed in the interior cavity.

In a further embodiment of any of the above, the attractant is selected from the group consisting of: avian feed, water, treat, and grit.

In a further embodiment of any of the above, a quantity of avian attractant is disposed in the storage container.

In a further embodiment of any of the above, the attractant is selected from the group consisting of: avian feed, water, treat, and grit.

In a further embodiment of any of the above, a coupling joins a first one of the plurality of links to a second one of the plurality of links; wherein the coupling comprises a second abrasive surface disposed on at least a portion of the coupling, the second abrasive surface constructed and arranged to remove material incrementally from an avian beak that is moved across the second abrasive surface when accessing the avian attractant.

In another embodiment, a beak trimming device is disclosed comprising: a feeder chain comprising a plurality of links; a coupling joining a first one of the plurality of links to a second one of the plurality of links; wherein at least one of the links comprises an interior cavity constructed and arranged to hold a quantity of avian attractant; and wherein the coupling comprises a first abrasive surface disposed on at least a portion of the coupling, the first abrasive surface constructed and arranged to remove material incrementally from an avian beak that is moved across the first abrasive surface when accessing the avian attractant.

In a further embodiment of any of the above, the abrasive surface comprises an abrasive grit applied to at least a portion of the at least one link.

In a further embodiment of any of the above, the abrasive surface comprises a roughening of a surface of at least a portion of the at least one link.

In a further embodiment of any of the above, the abrasive surface comprises at least one ridge disposed on at least a portion of the at least one link.

In a further embodiment of any of the above, the at least one ridge comprises a plurality of ridges disposed on at least a portion of the at least one link.

In a further embodiment of any of the above, a plurality of slots are formed through at least a portion of the at least one link, wherein the plurality of ridges comprise material of the at least one link adjacent a respective one of the plurality of slots bent away from a plane of the at least one link.

In a further embodiment of any of the above, a quantity of avian attractant is disposed in the interior cavity.

In a further embodiment of any of the above, the attractant is selected from the group consisting of: avian feed, water, treat, and grit.

In a further embodiment of any of the above, at least one of the links comprises a second abrasive surface disposed on at least a portion of at least one of the links, the second abrasive surface constructed and arranged to remove material incrementally from an avian beak that is moved across the second abrasive surface when accessing the avian attractant.

In another embodiment, an avian chain feeding system is disclosed comprising: a trough constructed and arranged to receive an avian attractant; a feeder chain comprising a plurality of links; a coupling joining a first one of the plurality of links to a second one of the plurality of links; wherein at least one of the links comprises an interior cavity constructed and arranged to hold a quantity of avian attractant; and wherein the coupling comprises a first abrasive surface disposed on at least a portion of the coupling, the first abrasive surface constructed and arranged to remove material incrementally from an avian beak that is moved across the first abrasive surface when accessing the avian attractant; and a drive unit operatively coupled to the feeder chain, wherein the drive unit is constructed and arranged to move the feeder chain through the trough.

In a further embodiment of any of the above, a storage container is constructed and arranged to hold the avian attractant and supply the avian attractant to the trough under force of gravity.

In a further embodiment of any of the above, a corner unit is provided; wherein the trough comprises at least a first trough section and a second trough section, each trough section including a proximal end and a distal end; and wherein the corner unit couples the proximal end of the first trough section to the distal end of the second trough section.

In a further embodiment of any of the above, the first trough section is oriented substantially 90 degrees from the second trough section when the first trough section and the second trough section are coupled to the corner unit.

In a further embodiment of any of the above, the trough comprises a feed trough.

In a further embodiment of any of the above, a grill is disposed over the trough, wherein the grill is constructed and arranged to prevent a bird from entering the trough while still allowing access to the trough for accessing the avian attractant therefrom.

In a further embodiment of any of the above, the abrasive surface comprises an abrasive grit applied to at least a portion of the at least one link.

In a further embodiment of any of the above, the abrasive surface comprises a roughening of a surface of at least a portion of the at least one link.

In a further embodiment of any of the above, the abrasive surface comprises at least one ridge disposed on at least a portion of the at least one link.

In a further embodiment of any of the above, the at least one ridge comprises a plurality of ridges disposed on at least a portion of the at least one link.

In a further embodiment of any of the above, a plurality of slots are formed through at least a portion of the at least one link, wherein the plurality of ridges comprise material of the at least one link adjacent a respective one of the plurality of slots bent away from a plane of the at least one link.

In a further embodiment of any of the above, a quantity of avian attractant is disposed in the interior cavity.

In a further embodiment of any of the above, the attractant is selected from the group consisting of: avian feed, water, treat, and grit.

In a further embodiment of any of the above, a quantity of avian attractant is disposed in the storage container.

In a further embodiment of any of the above, the attractant is selected from the group consisting of: avian feed, water, treat, and grit.

In a further embodiment of any of the above, at least one of the plurality of links comprises a second abrasive surface disposed on at least a portion of at least one of the plurality of links, the second abrasive surface constructed and arranged to remove material incrementally from an avian beak that is moved across the second abrasive surface when accessing the avian attractant.

Other embodiments are also disclosed.

### BRIEF DESCRIPTION OF DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 is a schematic top perspective view of an avian chain feeding system according to an embodiment.

FIG. 2 is a schematic top perspective view of a feeder chain according to an embodiment.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The presently disclosed embodiments include a feeder chain of an avian chain feeding system that is operative to trim the beak of a bird. An avian attractant is employed to encourage a bird to trim its beak by accessing the attractant from the feeder chain. One or more surfaces of the feeder chain include abrasive surfaces that, when contacted by the bird's beak, act to remove material incrementally from the beak, thus trimming the beak and keeping the beak trimmed.

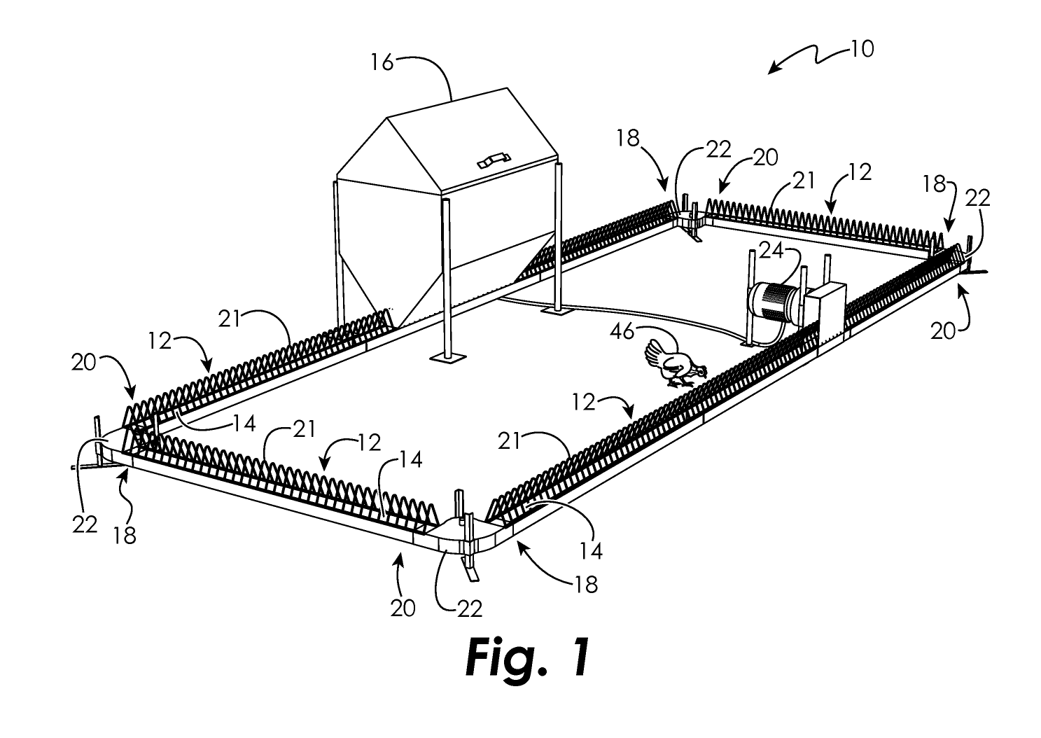

Referring to FIG. 1, one embodiment of an avian chain feeding system and beak trimming device is illustrated schematically and indicated generally at 10. The avian chain feeding system 10 includes a feed trough 12 formed in a plurality of sections and operative to receive a quantity of feed (not shown). Although the presently described embodiments describe use of the device with feed, it will be appreciated from the present disclosure that in other embodiments another attractant may be used, such as water, grit, treats, or another item or combination of items desirable to the bird. Additionally, although the illustrated embodiments describe use of a feed trough 12 formed in a plurality of sections, it will be appreciated by those skilled in the art that the feed trough 12 can be formed in a single piece, as the manner in which the feed trough 12 is formed and connected is not critical.

The feed trough 12 may receive the feed by any desired means, such as manually placing the feed into the feed trough 12 or directing the feed into the feed trough 12 by means of a conveyor belt, to name two non-limiting examples. In the illustrated embodiments, the feed enters an interior cavity 14 of the feed trough 12 from an overhead feed storage container 16 through an opening (not shown) in the bottom of the feed storage container 16.

The feed trough 12 may be mounted to the feed storage container 16, or not mounted thereto, as it will be appreciated by those skilled in the art that the manner in which the feed is provided to the feed trough 12 is not critical. In the illustrated embodiment, the feed in the feed storage container 16 exits the opening (not shown) in the bottom of the feed storage container 16 by force of gravity and is deposited into the interior cavity 14 of at least one of the sections of the feed trough 12.

In the illustrated embodiment, each of the sections of the feed trough 12 include a proximal end 18 and a distal end 20. In the illustrated embodiment, some sections of the feed trough 12 are coupled to one another by a corner unit 22 that couples the proximal end 18 of one section of the feed trough 12 to the distal end 20 of an adjacent section of the feed trough 12. In the illustrated embodiment, some sections of the feed trough 12 are coupled to each other with the proximal end 18 of one section of the feed trough 12 coupled directly to the distal end 20 of an adjacent section of the feed trough 12. A grill 21 may be disposed over the feed trough 12 to prevent a feeding bird 46 from entering the feed trough 12 while still allowing access to the interior cavity 14 of the feed trough 12 for feeding therefrom.

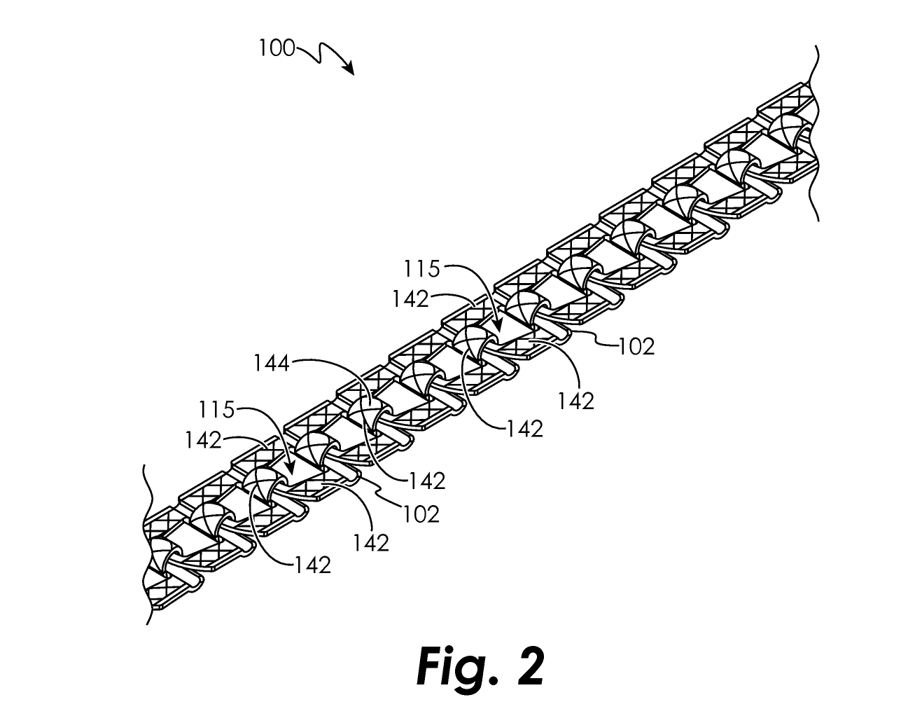

A feeder chain (one embodiment of which is illustrated in FIG. 2 as element 100) (not shown in FIG. 1) is disposed in the interior cavity 14 of the feed trough 12. The feeder chain is used to move feed from the feed storage container 16 to the location of the bird 46 feeding at the feed trough 12.

Referring to FIG. 2, the feeder chain 100 in some embodiments comprises multiple articulating links 102. In some embodiments, the multiple articulating links 102 are pulled through the feed deposited into the feed trough 12 by the feed storage container 16. Each of the links 102 includes an interior cavity 115 therein that traps a quantity of feed (not shown for clarity) as the links 102 are pulled through the feed supply. Additional feed may be pulled along with the feeder chain 100 due to the frictional forces acting between the links 102 and the feed.

In some embodiments, the feeder chain 100 is moved through the feed trough 12 by means of a drive unit 24 as is known in the art. The corner units 22 guide the feeder chain 100 around approximately 90 degree bends to form a continuous feeder chain 100 loop such that feed is continuously distributed through the feed trough 12 by action of the feeder chain 100 moved by the drive unit 24.

In some embodiments, at least one of the links 102 of the feeder chain 100 includes an abrasive surface 142. An abrasive surface may comprise any material or configuration that is operative to remove material incrementally from the bird's beak when the beak is moved across the material. In some embodiments, none of the links 102 of the feeder chain 100 include an abrasive surface 142.

In one embodiment, at least one coupling 144 connecting adjacent links 102 of the feeder chain 100 may have an abrasive surface 142, either in addition to, or instead of, the abrasive surface 142 on at least one link 102. As illustrated in FIG. 2 according to one embodiment, at least one coupling 144 connecting adjacent links 102 of the feeder chain 100 has an abrasive surface 142. In other embodiments, the abrasive surface 142 may cover only a portion of the coupling 144. In some embodiments, not all of the couplings 144 include an abrasive surface 142. In some embodiments, none of the couplings 144 include an abrasive surface 142.

In some embodiments, the abrasive surface may comprise an abrasive grit applied to one of the feeder chain 100 surfaces or a roughening of the surface itself, to name just two non-limiting examples. In some embodiments, the abrasive surface comprises one or more ridges protruding from the abrasive surface 142. Such ridges may be may be integrally formed in, or may be machined into, the abrasive surface 142 in some embodiments. In other embodiments, such ridges may be may be formed by cutting patterns into the abrasive surface 142 and then turning edges of the cut patterns up above the plane of the abrasive surface 142. Other abrasive surfaces may be used in other embodiments, as will be apparent to one of ordinary skill in the art in view of the present disclosure.

In operation for some embodiments, the drive unit 24 functions to pull the feeder chain 100 through the feed trough 12. Feed enters the feed trough 12 from the feed storage container 16 and falls onto the moving feeder chain 100. Each of the links 102 includes an interior cavity 115 therein that traps a quantity of feed as the links 102 are pulled through the feed supply. Additional feed may be pulled along with the feeder chain 100 due to the frictional forces acting between the links 102 and the feed. The feed is thus distributed throughout the feed trough 12 and acts as an attractant to the bird 46. The bird 46 can access the feed in the feed trough 12 through openings in the grill 21. As the bird 46 feeds on the feed in the feed trough 12, its beak will periodically rub against the abrasive surfaces 142 of the feeder chain 100, thereby incrementally removing material from the beak, thus keeping the beak trimmed. In some embodiments, as the bird 46 feeds on the feed in the feed trough 12, its beak will periodically rub against an abrasive surface on the coupling 144 of the feeder chain 100, thereby incrementally removing material from the beak, thus keeping the beak trimmed.

It will be appreciated from the presently disclosed embodiments that use of an attractant like the feed, water, grit, or other desirable attractant, to guide the beak of the bird 46 to an abrasive surface disposed in a position where the beak is likely to contact the abrasive surface when accessing the attractant, will function to remove material incrementally from the beak, thus trimming the beak and keeping the beak trimmed. Although the disclosed embodiments illustrate the concept in relation to accessing feed with a feed trough 12 and feeder chain 100 of a particular design, the concept is not so limited. Therefore, while the embodiments have been illustrated and described in detail in the drawings and foregoing description, the same is to be considered as illustrative and not restrictive in character, it being understood that only certain embodiments have been shown and described and that all changes and modifications that come within the spirit of the embodiments are desired to be protected.

What is claimed is:

1. A beak trimming device comprising:
a feeder chain comprising a plurality of links, wherein
at least one of the links comprises an interior cavity constructed and arranged to hold a quantity of avian attractant; and further wherein
at least one of the links comprises a first abrasive surface disposed on at least a portion of the at least one link, the first abrasive surface constructed and arranged to remove material incrementally from an avian beak that is moved across the first abrasive surface when accessing the avian attractant.

2. The device of claim 1, wherein the abrasive surface comprises an abrasive grit applied to at least a portion of the at least one link.

3. The device of claim 1, wherein the abrasive surface comprises a roughening of a surface of at least a portion of the at least one link.

4. The device of claim 1, wherein the abrasive surface comprises at least one ridge disposed on at least a portion of the at least one link.

5. The device of claim 4, wherein the at least one ridge comprises a plurality of ridges disposed on at least a portion of the at least one link.

6. The device of claim 5, further comprising a plurality of slots formed through at least a portion of the at least one link, wherein the plurality of ridges comprise material of the at least one link adjacent a respective one of the plurality of slots bent away from a plane of the at least one link.

7. The device of claim 1, further comprising a quantity of avian attractant disposed in the interior cavity.

8. The device of claim 7, wherein the attractant is selected from the group consisting of: avian feed, water, treat, and grit.

9. The device of claim 1, further comprising:
a coupling joining a first one of the plurality of links to a second one of the plurality of links;
wherein the coupling comprises a second abrasive surface disposed on at least a portion of the coupling, the second abrasive surface constructed and arranged to remove material incrementally from an avian beak that is moved across the second abrasive surface when accessing the avian attractant.

10. An avian chain feeding system comprising:
a trough constructed and arranged to receive an avian attractant;
a feeder chain comprising a plurality of links, wherein
at least one of the links comprises an interior cavity constructed and arranged to hold a quantity of the avian attractant; and further wherein
at least one of the links comprises a first abrasive surface disposed on at least a portion of the at least one link, the first abrasive surface constructed and arranged to remove material incrementally from an avian beak that is moved across the first abrasive surface when accessing the avian attractant; and
a drive unit operatively coupled to the feeder chain, wherein the drive unit is constructed and arranged to move the feeder chain through the trough.

11. The system of claim 10, further comprising:
a storage container constructed and arranged to hold the avian attractant and supply the avian attractant to the trough under force of gravity.

12. The system of claim 10, further comprising:
a corner unit;
wherein the trough comprises at least a first trough section and a second trough section, each trough section including a proximal end and a distal end; and
wherein the corner unit couples the proximal end of the first trough section to the distal end of the second trough section.

13. The system of claim 12, wherein the first trough section is oriented substantially 90 degrees from the second trough section when the first trough section and the second trough section are coupled to the corner unit.

14. The system of claim 10, wherein the trough comprises a feed trough.

15. The system of claim 10, further comprising:
a grill disposed over the trough, wherein the grill is constructed and arranged to prevent a bird from entering the trough while still allowing access to the trough for accessing the avian attractant therefrom.

16. The device of claim 10, wherein the abrasive surface comprises an abrasive grit applied to at least a portion of the at least one link.

17. The device of claim 10, wherein the abrasive surface comprises a roughening of a surface of at least a portion of the at least one link.

18. The device of claim 10, wherein the abrasive surface comprises at least one ridge disposed on at least a portion of the at least one link.

19. The device of claim 18, wherein the at least one ridge comprises a plurality of ridges disposed on at least a portion of the at least one link.

20. The device of claim 19, further comprising a plurality of slots formed through at least a portion of the at least one link, wherein the plurality of ridges comprise material of the at least one link adjacent a respective one of the plurality of slots bent away from a plane of the at least one link.

21. The device of claim 10, further comprising a quantity of avian attractant disposed in the interior cavity.

22. The device of claim 21, wherein the attractant is selected from the group consisting of: avian feed, water, treat, and grit.

23. The device of claim 11, further comprising a quantity of avian attractant disposed in the storage container.

24. The device of claim 23, wherein the attractant is selected from the group consisting of: avian feed, water, treat, and grit.

25. The system of claim 10, further comprising:
a coupling joining a first one of the plurality of links to a second one of the plurality of links;
wherein the coupling comprises a second abrasive surface disposed on at least a portion of the coupling, the second abrasive surface constructed and arranged to remove material incrementally from an avian beak that is moved across the second abrasive surface when accessing the avian attractant.

26. A beak trimming device comprising:
a feeder chain comprising a plurality of links;
a coupling joining a first one of the plurality of links to a second one of the plurality of links;
wherein at least one of the links comprises an interior cavity constructed and arranged to hold a quantity of avian attractant; and
wherein the coupling comprises a first abrasive surface disposed on at least a portion of the coupling, the first abrasive surface constructed and arranged to remove material incrementally from an avian beak that is moved across the first abrasive surface when accessing the avian attractant.

27. The device of claim 26, wherein the abrasive surface comprises an abrasive grit applied to at least a portion of the at least one link.

28. The device of claim 26, wherein the abrasive surface comprises a roughening of a surface of at least a portion of the at least one link.

29. The device of claim 26, wherein the abrasive surface comprises at least one ridge disposed on at least a portion of the at least one link.

30. The device of claim 29, wherein the at least one ridge comprises a plurality of ridges disposed on at least a portion of the at least one link.

31. The device of claim 30, further comprising a plurality of slots formed through at least a portion of the at least one link, wherein the plurality of ridges comprise material of the at least one link adjacent a respective one of the plurality of slots bent away from a plane of the at least one link.

32. The device of claim 26, further comprising a quantity of avian attractant disposed in the interior cavity.

33. The device of claim 32, wherein the attractant is selected from the group consisting of: avian feed, water, treat, and grit.

34. The device of claim 26, wherein at least one of the links comprises a second abrasive surface disposed on at least a portion of at least one of the links, the second abrasive surface constructed and arranged to remove material incrementally from an avian beak that is moved across the second abrasive surface when accessing the avian attractant.

35. An avian chain feeding system comprising:
a trough constructed and arranged to receive an avian attractant;
a feeder chain comprising a plurality of links;
a coupling joining a first one of the plurality of links to a second one of the plurality of links;
wherein at least one of the links comprises an interior cavity constructed and arranged to hold a quantity of avian attractant; and
wherein the coupling comprises a first abrasive surface disposed on at least a portion of the coupling, the first abrasive surface constructed and arranged to remove material incrementally from an avian beak that is moved across the first abrasive surface when accessing the avian attractant; and
a drive unit operatively coupled to the feeder chain, wherein the drive unit is constructed and arranged to move the feeder chain through the trough.

36. The system of claim 35, further comprising:
a storage container constructed and arranged to hold the avian attractant and supply the avian attractant to the trough under force of gravity.

37. The system of claim 35, further comprising:
a corner unit;
wherein the trough comprises at least a first trough section and a second trough section, each trough section including a proximal end and a distal end; and
wherein the corner unit couples the proximal end of the first trough section to the distal end of the second trough section.

38. The system of claim 37, wherein the first trough section is oriented substantially 90 degrees from the second trough section when the first trough section and the second trough section are coupled to the corner unit.

39. The system of claim 35, wherein the trough comprises a feed trough.

40. The system of claim 35, further comprising:
a grill disposed over the trough, wherein the grill is constructed and arranged to prevent a bird from entering the trough while still allowing access to the trough for accessing the avian attractant therefrom.

41. The device of claim 35, wherein the abrasive surface comprises an abrasive grit applied to at least a portion of the at least one link.

42. The device of claim 35, wherein the abrasive surface comprises a roughening of a surface of at least a portion of the at least one link.

43. The device of claim 35, wherein the abrasive surface comprises at least one ridge disposed on at least a portion of the at least one link.

44. The device of claim 43, wherein the at least one ridge comprises a plurality of ridges disposed on at least a portion of the at least one link.

45. The device of claim 44, further comprising a plurality of slots formed through at least a portion of the at least one link, wherein the plurality of ridges comprise material of the at least one link adjacent a respective one of the plurality of slots bent away from a plane of the at least one link.

46. The device of claim 35, further comprising a quantity of avian attractant disposed in the interior cavity.

47. The device of claim 46, wherein the attractant is selected from the group consisting of: avian feed, water, treat, and grit.

48. The device of claim 36, further comprising a quantity of avian attractant disposed in the storage container.

49. The device of claim 48, wherein the attractant is selected from the group consisting of: avian feed, water, treat, and grit.

50. The system of claim 35, wherein at least one of the plurality of links comprises a second abrasive surface disposed on at least a portion of at least one of the plurality of links, the second abrasive surface constructed and arranged to remove material incrementally from an avian beak that is moved across the second abrasive surface when accessing the avian attractant.
